(19) United States
(12) Patent Application Publication
(10) Pub. No.: US 2018/0195653 A1
(43) Pub. Date: Jul. 12, 2018

(54) SWIVEL JOINT FOR FLARE SYSTEM OF OFFSHORE PLANT

(71) Applicant: SEBO TECH CO., LTD., Busan (KR)

(72) Inventors: Hong-Woo JEON, Busan (KR); Hang-Bum CHO, Gimhae (KR); Do-Kyeong LEE, Busan (KR); Tae-Uk HEO, Yangsan (KR); Tae-Haeng BAN, Busan (KR)

(21) Appl. No.: 14/344,307

(22) PCT Filed: Feb. 6, 2014
(86) PCT No.: PCT/KR2014/001021

§ 371 Date: Mar. 11, 2014

(30) Foreign Application Priority Data
Feb. 7, 2013 (KR) 10-2013-0014084

(51) Int. Cl. F16L 27/08; F16L 27/087

(52) U.S. Cl. CPC F16L 27/0828; F16L 27/087; F16L 27/0816; F16L 27/0837

(57) ABSTRACT

Provided is a swivel joint for flare system of offshore plant which can be semi-permanently operated even with grease injected once.

The swivel joint for flare system of offshore plant proposed comprises a cylindrical body; and first and second connecting members coupled to opposite sides of the cylindrical body, respectively.

The swivel joint has an advantage that it can be actually semi-permanently used with the grease initially injected and then the sealing made.

### TECHNICAL FIELD

The present invention relates to a swivel joint, more particularly, a swivel joint for flare system of offshore plant which can be semi-permanently operated even with grease injected once.

### BACKGROUND ART

In general, since, unlike common vessels, the offshore plant consisting of a fixed type, floating type or flexible type structure is used for from about 3 years up to 30 years after installed on a oil or gas-drilling site, corresponding considerations for design are also quite strict. Various technologies with a high degree of difficulty is required in connection with effects of weather such as wind or wave, special environmental circumstance of the sea and securement of safety against fire and explosion due to production of oil product.

In recent, due to increase of demand to exploit oil resource in the deep sea with the depth of 1,000 m or more, securement and development of related technologies are in progress diversely, and there is a trend of progressive increase of demand for and an interest in development of a multi-purpose offshore plant which can simultaneously perform functions of drilling, producing, storing etc., while an interest in existing single-purpose offshore plant for performing a single function is on a decreasing trend.

Technique for designing an offshore plant for oil and gas resources and technologies for an offshore plant for utilization of the sea space must be firstly secured since they have a relatively high feasibility in view of current domestic industrial bases and technical level, and such technique and technologies are commonly directed to securing of offshore plant engineering technologies, therefore, the degree of concentration of technology investment and its ripple effect are expected to be high.

### DISCLOSURE OF INVENTION

### Technical Problem

Complying with such a current demand, the present invention wants to propose a new structure for a swivel joint specially applied to a flare system among a number of devices, systems and modules constituting the offshore plant.

In general, the flare system consists of water injection nozzles, swivel joints, sea fastening structure, foundation etc.

As everyone knows, the swivel joint of the flare system is a member interconnecting a hull-side line and a line of the flare system, and serves to allow the flare system to swing through an angle of 0° to 180° depending on wind, in consideration of influence of wind on waste oil, waste gas etc. spouting out from the bottom of the sea.

Namely, the swivel joint is a device for connecting pipes with each other, and allows gas and fluid to stably flow even if a burner boom rotates.

By the way, expensive swivel joints for flare system all presently imported from foreign advanced companies are grease-injection type, and have problems that they periodically require post management, which is inconvenient, and that a lot of rust occur due to the ingress of pollutants into nipple.

For example, in the case of most of the swivel joints presently imported and sold (in particular, high-pressure swivel joint (working pressure: 500 bar or more)), there are problems that a delivery period is long, for example, about 6 months or more, in the case of order for production of small quantity and that a import price is high, for example, about \ 300-500 million apiece. In addition, regarding the quality of material used in a shipbuilding yard and design, a lot of complaints are received from ship owners as maintenance cost increases due to occurrence of oil supply problem and occurrence of rust due to inferiority of nipple in long-time use of the swivel joint.

### Solution to Problem

The present invention has been proposed for solving the above-mentioned problems, and its object is to provide a swivel joint of oilless low-pressure to high-pressure line.

The swivel joint developed by the present invention has an effect that inferiority due to external supply of oil is reduced by adopting an oilless bearing and maintenance cost decreases because of adoption of oilless function.

The swivel joint for flare system of offshore plant proposed by the present invention comprises a cylindrical body; and first and second connecting members coupled to opposite sides of the cylindrical body, respectively.

The first connecting member comprise a first cylindrical cover one side of which is coupled to one side of the cylindrical body by means of fastening members; a first elbow member one side of which is coupled to the other side of the first cylindrical cover; and a first flange which is coupled to the other side of the first elbow member and to which a pipe is connected.

The second connecting member comprises a second cover with a circular opening formed at its center; a cylindrical shaft one side of which is coupled to inner diameter part of the second cover; a second elbow member one side of which is coupled to the other side of the cylindrical shaft; and a second flange which is coupled to the other side of the second elbow member and to which an external pipe able to make a turning movement is connected.

On inner diameter part of the cylindrical body, a predetermined partition is formed which extends along the inner diameter part round the part, and on a right side relative to the partition, a first bearing is inserted and seated which is formed in such a way that its outer diameter part has a predetermined step, and on a left side relative to the partition, a second bearing is seated which has a shape symmetrical to the first bearing, and a bearing cover is provided which is seated in the cylindrical body while being interposed between the first cover and the first bearing, and in the state of the second connecting member being coupled to the cylindrical body, grease is injected through a hole for plug formed in the second cover, and the plug then makes sealing with an O-ring being interposed.

In the present invention, it is preferred that an O-ring is interposed between the cylindrical body and the first cover in order to form a closed structure, and an O-ring is interposed between the cylindrical body and the second cover in order to form a closed structure.

### Advantageous Effects of Invention

The swivel joint according to the present invention has an advantage that it can be actually semi-permanently used with the grease initially injected and then the sealing made.

### BRIEF DESCRIPTION OF DRAWINGS

FIG. 1 is a perspective exterior view of a swivel joint proposed by the present invention.

FIG. 2 is an assembly view of the swivel joint proposed by the present invention.

### MODE FOR THE INVENTION

In the following, an embodiment of a swivel joint applied to a flare system of offshore plant proposed by the present invention will be described in detail with reference to the drawings.

The swivel joint proposed by the present invention is a member which interconnects various lines(for example, Choke & Kill Line, Oil Line etc.) used in the plant and flare system while being connected thereto for normal operation of the flare system.

In general, the number and specifications of the swivel joints are determined depending on gas (SO2 etc.), oil etc. produced in drilling, and the number of main lines is seven at the minimum and twelve at the maximum.

The types of the line are as follows:

a) Oil Well Line, b) Sea Water Line(Flare & Water Shield), c) Ignition Line, d) Pilot Gas Line, e) Fuel Line, f) Choke & Kill Line, g) Compressive Air Line, and h) H2S Line.

Each of the lines may determine the specifications of the main swivel joint according to the specifications of drilling pipe practice of a shipbuilding yard, and the chock & kill line, which is a well test line, oil well line etc. are mainly used for high pressure, and thus a swivel joint meeting criteria of NACE (National Association of Corrosion Engineers) and Sour Gas Service. is used.

It is a cautionary factor associated with production of the swivel joint that since, in welding of material with thickness of 19 mm or more, inferiority of welding occurs due to a temperature difference between the temperature of base material plate and the temperature of the material to be welded, preheating prior to welding and post heating for stress relief after welding are important.

In addition, after welding, strength must be checked by checking a heat affected zone of weld zone and the presence of defects of the weld zone (by means of nondestructive testing) and measuring hardness thereof.

Sealing must be achieved through packing or O-ring etc. so that high-pressure gas and fluid cannot escape to the outside.

Since casualties and property damage are feared to occur if the sealing is not well achieved, it is necessary to evaluate safety through a test for checking whether or not an accurate sealing is achieved by blocking one side of the swivel joint and then flowing high-pressure gas toward the other side.

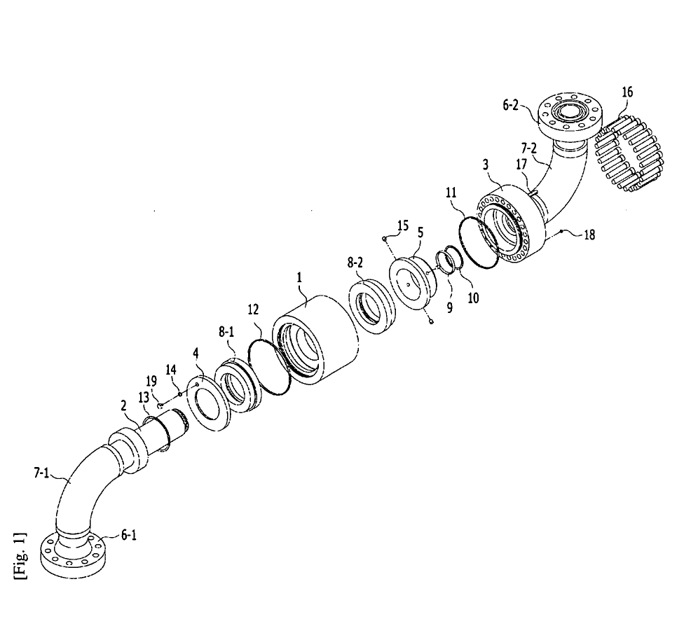

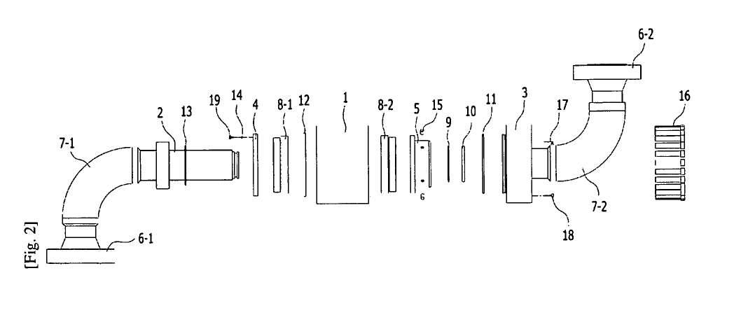

In the following, components of the swivel joint intended to be applied to the flare system of the offshore plant proposed by the present invention will be described with reference to FIGS. 1 to 2.

As illustrated in FIG. 1, the swivel joint according to the present invention comprises a cylindrical body (1), a first connecting member inserted and coupled in one end portion of the body (1), and a second connecting member inserted and coupled in the other end portion of the body (1).

The first connecting member comprises a cylindrical cover (3) one side of which is coupled to one side of the cylindrical body (1) by means of fastening members (16), an elbow member (7-2) one side of which is coupled to the other side of the cylindrical cover (3), and a flange (6-2) which is coupled to the other side of the elbow member (7-2) and to which an external pipe is connected or fastened.

Next, the second connecting member comprises a disc-type cover (4) with a circular opening formed at its center, a cylindrical shaft (2) one side of which is coupled to inner diameter part of the disc-type cover (4), an elbow member (7-1) one side of which is coupled to the other side of the cylindrical shaft (2), and a flange (6-1) which is coupled to the other side of the elbow member (7-1) and to which an external pipe able to make a turning movement is connected.

In the following, each of the components will be described in more detail.

The body (1) is a body whose external shape is cylindrical. Bearings (8-1, 8-2) are each seated on inner diameter part of the body in close contact with the part. The body serves to protect the shaft (2) and is coupled to the first connecting member (the cylindrical cover (3), the elbow member (7-2) and the flange (6-2)) by means of the fastening members (16).

The shaft (2) is a cylindrical rotatable shaft defining a flow passage through which fluid flows, and is inserted in inner diameter part of the bearing (8-1) so as to be smoothly rotated, and serves to prevent occurrence of eccentricity.

The shaft (2) is sequentially coupled to the elbow member (7-1) and the flange (6-1), and an end portion of the flange (6-1) is connected to an external pipe(not shown) which makes a rotation or swing movement.

The cylindrical cover (3) serves to seal a gap between the body (1) and the first connecting member as a fixed part and prevent leakage after the bearing (8-2) and a bearing cover (5) are inserted and mounted in the body. The bearing cover (5) servers to support the bearing (8-2) inserted in the body (1), while being in close contact with the bearing.

The cylindrical body (3) is formed with a plurality of through holes between its inner diameter part and outer diameter part, and is coupled to the body (1) by the fastening members (16) passing through the plurality of through holes.

As the fastening members (16), bolts etc. for axial coupling may be used, and spring washers etc. may be inserted to prevent release of the bolts.

It is preferred that an O-ring is interposed between the body (1) and the cylindrical cover (3) to form a closed structure.

Meanwhile, the elbow member (7-2) is connected to the flange (6-2) as illustrated in the figures.

For reference, the flange (6-2) is connected to a fixed external pipe, and the flange (6-1) is connected to a pipe that makes a rotation or swing(turning) movement. Alternatively, an opposite case is also applicable.

Next, the disc-type cover (4) constituting the second connecting member serves to press the bearing (8-1) into the body (1).

As illustrated, the elbow member (7-1) connected to the shaft (2) is connected to the flange (6-1).

Next, the bearings (8-1, 8-2) seated on the inner diameter part of the body (1) preferably consist of a spherical roller thrust bearing.

If such thrust bearings (8-1, 8-2) utilizing spherical rollers are seated, installation error of the inner diameter part of the body (1) or bending of the shaft etc. can be absorbed, and outer diameter parts of these bearings (8.1, 8.2) are mounted in close contact with the inner diameter part of the body (1), thereby supporting axial force resulting from fluid pressure.

A space for mounting a seal member (9) is formed on an end portion of the shaft (2), and it is preferred that chrome coating is applied to prevent corrosion.

The seal member (9) seals a gap between the cover (3) of the first connecting member and the end portion of the shaft (2) to prevent the fluid flowing within the shaft from escaping to the outside.

Furthermore, if the flowing fluid is at high pressure, a back-up ring (10) etc. may be used for supporting the seal member (9).

Meanwhile, O-rings (11, 12, 13, 14) used in the present invention serve to form a closed structure wherein grease, which is supplied by being firstly injected into the body (1) through a hole for plug formed at one side of the cover (4), is prevented from escaping to the outside.

In the case of the present invention, re-filling is not required until end of product's life after filling of the grease.

In the present invention, after filling of the grease, a plug (19) makes sealing with the O-ring (14) being interposed.

In the drawings, a set screw (15) is a component fixed by being screwed in order to prevent release of the bearing cover (5) after assembling of the bearing cover with the shaft (2). A relief fitting (17) is a component for preventing damage to the product due to leakage of pressure, and serves to safely protect components within the body (1) by lowering high pressure so that the fluid can escape to the outside when leakage occurs due to unexpected damage to the seal member (9). A wrench plug (18) is a tapped hole serving as an examination hole for checking the presence of leakage in air-tightness test after first assembling of the present product, and is sealed by a sealing member after completion of examination. A hole for the plug (19) formed in the cover (4) is initially used as a hole for filling the grease and, after filling, is sealed by the plug (19) with the O-ring (14) being interposed.

In the following, overall construction of the present invention will be described with reference to FIGS. 1 to 2.

On the inner diameter part of the cylindrical body (1) constituting the swivel joint of the present invention, a predetermined partition is formed which extends along the inner diameter part round the part. On a right side relative to the partition, the donut-like bearing (8-2) is inserted and seated which is formed in such a way that its outer diameter part has a predetermined step, and on a left side relative to the partition, the bearing (8-1) is seated which has a shape symmetrical to the bearing (8-2).

The bearing cover (5) is seated in the body (1) while being interposed between the cover (3) and the bearing (8-2). In the state of the second connecting member being completely coupled to the cylindrical body (1), the grease is injected through the hole for the plug (19) formed in the cover (4), and the plug (19) then makes sealing with the O-ring (14) being interposed.

Meanwhile, in the present invention, the O-ring (11) is interposed between the body (1) and the cover (3) in order to form a closed structure and the O-ring (12) is interposed between the body (1) and the cover (4) in order to form a closed structure, whereby outward leakage of the grease and oxidation thereof due to contact with outside air can be prevented.

Therefore, the swivel joint according to the present invention has an advantage that it can be actually semi-permanently used with the grease initially injected and then the sealing made.

### LIST OF REFERENCE NUMERALS

1: cylindrical body 2: cylindrical shaft

3: cover 4: cover

5: bearing cover 6-1, 6-2: flange

7-1, 7-2: elbow member 8-1, 8-2: bearing

9: seal member 10: back-up ring

11, 12, 13, 14: O-ring 15: set screw

16: fastening member 17: relief fitting

18: wrench plug 19: plug

1. A swivel joint for flare system of offshore plant,
wherein the swivel joint comprises,
a cylindrical body; and
first and second connecting members coupled to opposite sides of the cylindrical body, respectively, and
the first connecting member comprise,
a first cylindrical cover one side of which is coupled to one side of the cylindrical body by means of fastening members;
a first elbow member one side of which is coupled to the other side of the first cylindrical cover; and
a first flange which is coupled to the other side of the first elbow member and to which a pipe is connected,
the second connecting member comprises,
a second cover with a circular opening formed at its center;
a cylindrical shaft one side of which is coupled to inner diameter part of the second cover;
a second elbow member one side of which is coupled to the other side of the cylindrical shaft; and
a second flange which is coupled to the other side of the second elbow member and to which an external pipe able to make a turning movement is connected,
on inner diameter part of the cylindrical body, a predetermined partition is formed which extends along the inner diameter part round the part,
on a right side relative to the partition, a first bearing is inserted and seated which is formed in such a way that its outer diameter part has a predetermined step, and
on a left side relative to the partition, a second bearing is seated which has a shape symmetrical to the first bearing,
a bearing cover is provided which is seated in the cylindrical body while being interposed between the first cover and the first bearing, and
in the state of the second connecting member being coupled to the cylindrical body, grease is injected through a hole for plug formed in the second cover, and the plug then makes sealing with an O-ring being interposed.

2. The swivel joint for flare system of offshore plant according to claim 1,
wherein an O-ring is interposed between the cylindrical body and the first cover in order to form a closed structure, and an O-ring is interposed between the cylindrical body and the second cover in order to form a closed structure.
